(19) United States
(12) Patent Application Publication
(10) Pub. No.: US 2026/0038136 A1
(43) Pub. Date: Feb. 5, 2026

(54) SYSTEM AND METHOD FOR IDENTIFYING WHEN A TARGET CHARACTERISTIC OF AN OBJECT IN AN INPUT IMAGE SCENE IS DEEMED TO RENDER THE OBJECT TO BE AN OBJECT-OF-INTEREST

(71) Applicant: Booz Allen Hamilton Inc., McLean, VA (US)

(72) Inventors: Bruce Andrew JOHNSON, Marana, AZ (US); Lusine KAMIKYAN, Washougal, WA (US)

(73) Assignee: Booz Allen Hamilton Inc., McLean, VA (US)

(21) Appl. No.: 19/286,229

(22) Filed: Jul. 30, 2025

Related U.S. Application Data
(60) Provisional application No. 63/677,588, filed on Jul. 31, 2024.

(51) Int. Cl. G06T 7/543; G06T 7/73; G06V 20/59; G06V 40/10

(52) U.S. Cl. CPC G06T 7/543; G06T 7/75; G06V 20/59; G06V 40/103; G06T 2207/30196; G06T 2207/30212

(57) ABSTRACT

Embodiments relate to a system for determining when an object should be an object-of-interest. An input module receives an image scene captured by an image capture device. A processor performs a shape analysis technique, wherein a first processing module scans the image scene to identify an object, a second processing module identifies a shape of interest of the object, a third processing module compares the shape of interest to a reference shape, and a fourth processing module classifies the object as having a target characteristic when the shape of interest matches the reference shape. The processor compares an interior area of an image curve of the classified object to an interior area of an image curve of the reference shape to generate a scale factor, and designates the classified object as an object-of-interest based on the scale factor.

### CROSS-REFERENCE TO RELATED APPLICATIONS

This patent application is related to and claims the benefit of priority of U.S. provisional patent application No. 63/677,588, filed on Jul. 31, 2024, the entire content of which is incorporated herein by reference.

### FIELD

Embodiments can relate to systems and methods for determining how and when an object should be an object-of-interest.

### BACKGROUND INFORMATION

Unmanned vessels are serving as force multipliers by those who seek to engage in asymmetric warfare against larger navies. These unmanned vessels may be accompanied by manned vessels of a comparable size and performance. When these unmanned vessels are encountered, they may be destroyed with impunity. However, manned vessels may not be so easily dispatched without inviting further retaliation. Hence, it is imperative that a quick distinction can be made between a manned or unmanned vessel in order to ensure that a correct engagement policy can be implemented.

Known techniques can be appreciated from.
US20230303110 Alibeigi et al.
CN 115100527 Yang et al.
CN 116109845 Chen et al.
CN 117333807 Cao et al.
CN 117636060 Du et al.
Liu, M., Wang, X., Zhou, A., Fu, X., Ma, Y., & Piao, C. (2020). UAV-YOLO: Small Object Detection on Unmanned Aerial Vehicle Perspective. Sensors, 20(8), 2238.
Yin, T., Chen, W., Liu, B., Li, C., & Du, L. (2023). Light “You Only Look Once”: An Improved Lightweight Vehicle-Detection Model for Intelligent Vehicles under Dark Conditions. Mathematics, 12(1), 124.
Park, M., & Ko, B. C. (2020). Two-Step Real-Time Night-Time Fire Detection in an Urban Environment Using Static ELASTIC-YOLOv3 and Temporal Fire-Tube. Sensors, 20(8), 2202.
Liu, K. (2020 November). Deep Associated Elastic Tracker for Intelligent Traffic Intersections. In Proceedings of the 2nd International Workshop on Challenges in Artificial Intelligence and Machine Learning for Internet of Things (pp. 55-61).
Kumar, S., Jailia, M., Varshney, S., Pathak, N., Urooj, S., & Elmunim, N. A. (2023). Robust Vehicle Detection Based on Improved You Look Only Once. Computers, Materials & Continua, 74(2).
Zhang, Y., Guo, Z., Wu, J., Tian, Y., Tang, H., & Guo, X. (2022). Real-Time Vehicle Detection Based on Improved Yolo V5. Sustainability, 14(19), 12274.
Carrasco, D. P., Rashwan, H. A., García, M. Á., & Puig, D. (2021). T-YOLO: Tiny vehicle detection based on YOLO and multi-scale convolutional neural networks. IEEE Access, 11, 22430-22440.

### SUMMARY

An exemplary embodiment can relate to a system for identifying when a target characteristic of an object in an input image scene is deemed to render the object to be an object-of-interest. The system can include an input module for receiving in real time an image scene captured by an image capture device. The system can include a processor including plural processing modules for performing a shape analysis technique. The processor can include a first processing module for scanning the image scene to identify an object. The processor can include a second processing module for identifying a shape of interest of the object. The processor can include a third processing module comparing the shape of interest to a reference shape. The processor can include a fourth processing module for classifying the object as having a target characteristic when the shape of interest matches the reference shape. The processor can be configured to compare an interior area of an image curve of the classified object to an interior area of an image curve of the reference shape to generate a scale factor. The processor can be configured to designate the classified object as an object-of-interest based on the scale factor. The system can include a user interface configured to generate an output identifying the object as an object-of-interest or as a non-object-of-interest.

An exemplary embodiment can relate to a method for identifying when a target characteristic of an object in an input image scene is deemed to render the object to be an object-of-interest. The method can include receiving in real time an image scene captured by an image capture device. The method can include performing a shape analysis technique by scanning the image scene to identify an object, identifying a shape of interest of the object, comparing the shape of interest to a reference shape, classifying the object as having a target characteristic when the shape of interest matches the reference shape. The method can include comparing an interior area of an image curve of the classified object to an interior area of an image curve of the reference shape to generate a scale factor. The method can include designating the classified object as an object-of-interest based on the scale factor.

### BRIEF DESCRIPTION OF THE DRAWINGS

Other features and advantages of the present disclosure will become more apparent upon reading the following detailed description in conjunction with the accompanying drawings, wherein like elements are designated by like numerals, and wherein:

FIG. 1 shows an exemplary system diagram;

FIG. 2 shows an exemplary process flow diagram;

FIG. 3 shows an exemplary flowchart illustrating an exemplary range estimation method of filtering out extraneous objects;

FIG. 4 shows detection of a machine gun in a manned and armed vessel based on only a reference shape;

FIG. 5 shows detection of humans based on only a reference silhouette;

FIG. 6 illustrates contour detection;

FIG. 7 illustrates noise and obscuration;

FIG. 8 illustrates detection of a machine gun in the presence of noise and obscurations;

FIG. 9 illustrates detection of humans in the presences of noise and obscurations;

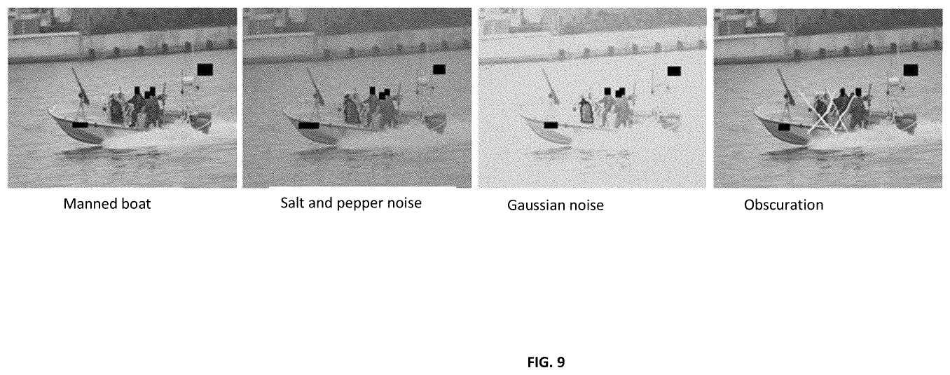

FIG. 10 illustrates that no machine gun or human has been detected in an instance of an unmanned vessel, and humans have been detected in instances of manned vessels;

FIG. 11 illustrates an instance of failure with an embodiment of the APSA;

FIG. 12 illustrates detection in noise and obscuration;

FIG. 13 illustrates the absence of detection of humans and machine guns in unmanned vessels in the presence of noise and obscuration;

FIG. 14 illustrates the absence of detection of humans and machine guns in unmanned vessels in the presence of noise and obscuration; and

FIG. 15 illustrates the absence of detection of humans and machine guns in unmanned vessels in the presence of noise and obscuration.

### DETAILED DESCRIPTION

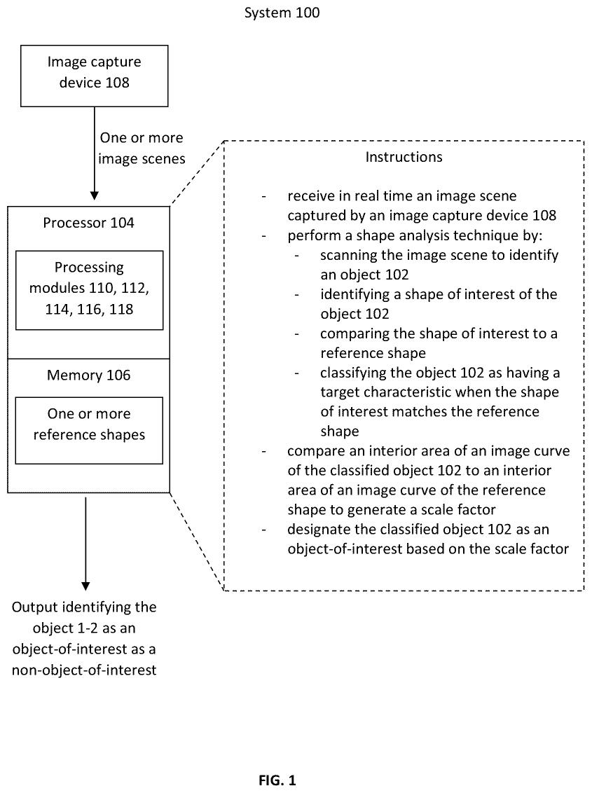

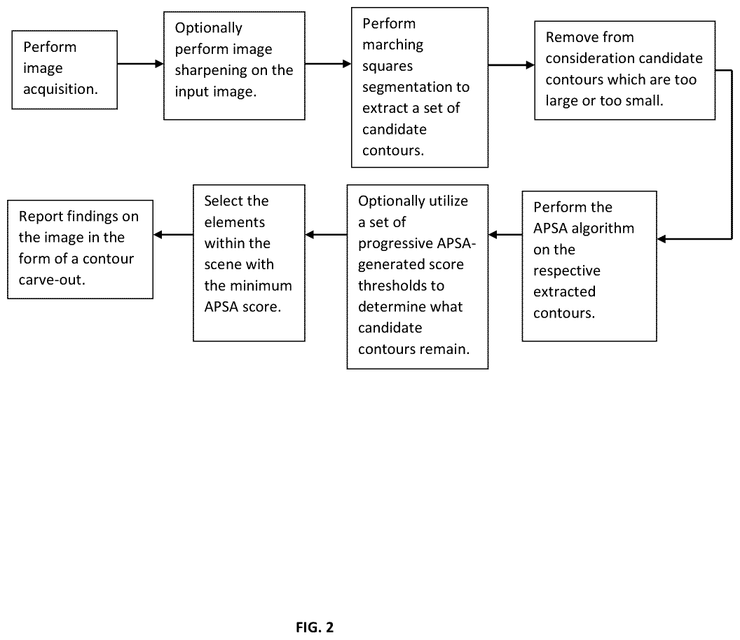

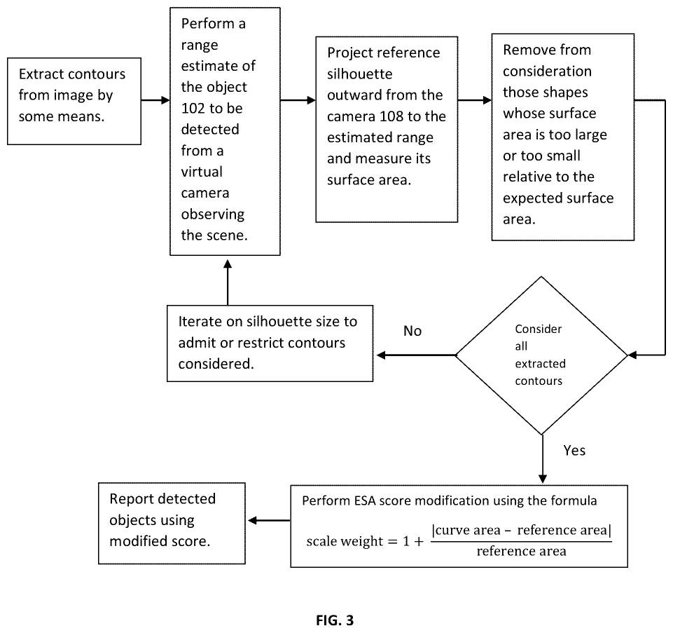

Referring to FIGS. 1-3, an exemplary embodiment can relate to a system 100 for identifying when a target characteristic of an object 102 in an input image scene is deemed to render the object 102 to be an object-of-interest. As will be explained herein, the system 100 and/or any of its components can include one or more processors 104. The system 100 and/or any of its components can also include one or more memories 104. The processor(s) 104 can be any of the processors disclosed herein. The processor 104 can be part of or in communication with a machine (logic, one or more components, circuits (e.g., modules), or mechanisms). The processor 104 can be hardware (e.g., processor, integrated circuit, central processing unit, microprocessor, core processor, computer device, and so forth), firmware, software, and so forth configured to perform operations by execution of instructions embodied in algorithms, data processing program logic, artificial intelligence programming, automated reasoning programming, and so forth Use of processors 104 herein can include any one or combination of a Graphics Processing Unit (GPU), a Field Programmable Gate Array (FPGA), a Central Processing Unit (CPU), and so forth The processor 104 can include one or more sub-processors or processing modules. A sub-processor or processing module can be a software or firmware operating module configured to implement any of the method steps disclosed herein. The sub-processor or processing module can be embodied as software and stored in memory 106, the memory 106 being operatively associated with the processor 104. A sub-processor or processing module can be embodied as a web application, a desktop application, a console application, and so forth

The processor 104 can include or be associated with a computer or machine readable medium. The computer or machine readable medium can include memory 106. The computer or machine readable medium can be configured to store one or more instructions thereon. The instructions can be in the form of algorithms, program logic, a model, and so forth that cause the processor 104 to perform any of the functions described herein.

Any of the memory 106 discussed herein can be computer readable memory configured to store data. The memory 106 can include a volatile or non-volatile, transitory or non-transitory memory, and be embodied as an in-memory, an active memory, a cloud memory, and so forth Embodiments of the memory 106 can include a sub-processor or processor module and other circuitry to allow for the transfer of data to and from the memory 106, which can include to and from other components of a communication system. This transfer can be via hardwire or wireless transmission. The communication system can include transceivers, which can be used in combination with switches, receivers, transmitters, routers, gateways, wave-guides, and so forth to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, and so forth

The processor 104 can be in communication with other processors of other devices (e.g., a computer device, a desktop computer, a laptop computer, a computer system, and so forth). Any of those other devices can include any of the exemplary processors disclosed herein. Any of the processors 104 can have transceivers or other communication devices/circuitry to facilitate transmission and reception of wireless signals. Any of the processors 104 can include an Application Programming Interface (API) as a software intermediary that allows two applications to talk to each other. Use of an API can allow software of the processor 104 of the system 100 to communicate with software of the processor 104 of the other device(s), if the processor 104 of the system 100 is not the same processor of the device.

Any data transmission between the processor 104 and memory 106, between the processor 104 and a database, and between the processor 104 and processors 104 of other devices, and so forth can be via a pull operation (e.g., the processor 104 can pull the data) or a push operation (e.g., the data can be pushed to the processor 104). The processor 104 can receive the data in steaming format, or store it in memory 106 before being processed. In addition, embodiments of the algorithm, model, and so forth disclosed herein can be developed as an application software (an “App”) to be implemented on a processor 104 of a device. The App can be sent via a steaming format, or the App can be sent and stored on a memory associated with or accessed by the device.

As noted herein, the processor 104 can be configured to be a component of, used in combination with, or in communication with another device/system—e.g., this can include the processor 104 being part of the device/system, the device/system being part of the processor 104, the processor 104 in communication with the device/system, and so forth “Being part of” can include being on a same substrate or integrated circuit. For instance, the processor 104 can be a component of, used in combination with, or in communication with a predictive modeling system, a decision support system, an automated control system, and so forth The processor 104 can use a model or algorithm disclosed herein or provide the model or algorithm to the device/system to assist with or augment the performance of these devices/systems.

The system 100 can include an input module 110 (or input sub-processor) for receiving in real time an image scene captured by an image capture device 108. While it is contemplated for the input module 110 to be configured to receive an image scene in real time, it can receive the image scene from storage (e.g., not in real time). The input module 110 can be configured to receive one or more image files representative of the image scene, a segment of the image scene, multiple image scenes, and so forth. The image files can be received on a continuous basis, in a batch-processed bases, as determined by an algorithm, on-demand by a user, and so forth. The image files can be digital image files. For instance, the input module 110 can be or include a digital receiver configured to receive digital signals representative of an image scene, and convert or process the digital signals for further analysis. The conversion or processing can involve converting an image file to a digital matrix of pixel data or voxel data. The input module 110 can include, be part of, in communication with, and so forth an image capture device 108 (e.g., a digital camera) configured to generate image files (e.g., imagery, video, and so forth) of image scenes. Thus, the image capture device 108 can capture images or video of an image scene and transmit it/them to a data store to be transmitted to the input module 110, transmit it/them to the input module 110, transmit it/them to a processing unit for pre-processing prior to being transmitted to the input module 110, and so forth.

The image scene can be a region of concern. For instance, the image scene can be a region in front of a seagoing vessel, and the image capture device 108 can be used to generate one or more image files of the region. The object(s) 102 can be image objects representative of a seaborne vessel, an airborne vessel, and so forth. Any one or combination of the image files can be representative of the image scene. The system 100 can provide parameters (automatically via the processor 104, automatically via another processor, manually via a user and a user interface in communication with the processor 104, and so forth) to the image capture device 108 that defines the region of concern and/or the system 100 can provide parameters (automatically or manually via a user and a user interface) to the input module 110 that defines the image scene. The parameters can be generated via programming logic, via a user through a user interface, via an artificial intelligence model, and so forth. The input module 110 can utilize an image stitching technique to stitch image files together if it is necessary to do so in order to generate the image scene. An exemplary stitching process can involve aligning two or more image files via an image registration technique. This can involve performing a geometric transformation (e.g., translation, rotation, scaling, and so forth) to map (e.g., matching key features of overlapping regions of the images) one or more image files to one or more other image files. The key features can be identified via a user, via feature detection algorithms, via trained artificial intelligence models, and so forth. Geometric transformations can be performed manually via a user, via an algorithm (e.g., Ransom Sample Consensus), and so forth. Additional processing, such as image warping, blending, and so forth can also be performed. The combined images can then be rendered into a single stitched image file representative of the image scene.

The processor 104 can include one or more processing modules (or sub-processors) for performing a shape analysis technique. For instance, the processor 104 can include a first processing module 112 for scanning the image scene to identify one or more objects 102. The first processing module 112 can scan the image scene (e.g., scan the image file(s) representative of the image scene) to identify object(s) 102 using a computer vision technique, for example. For instance, the first processing module 112 can be configured to analyze the image file(s) via a computer vision algorithm that segments the image file(s) into smaller components. The first processing module 112 can extract features (e.g., edges, corners, contours, and so forth) which can be used to recognize and classify an object 102. Machine learning techniques can be used to learn object features—e.g., detect and classify objects 102. The first processing module 112 can predict bounding boxes around potential objects 102 which can be used by the machine learning algorithm to classify the objects 102. The machine learning algorithm can be trained to detect objects 102 as seaborne vessels, for example. The first processing module 112 can generate a data structure representative of the identified/detected/classified objects 102 with bounding boxes and transmit the same to memory 106 for storage and later processing (e.g., processing by the second processing module 114). In the alternative, the data structure can be transmitted directly to the second processing module 114.

The processor 104 can include a second processing module 114 for identifying one or more shapes of interest of one or more objects 102. For instance, the first processing module 112 can identify one or more objects 102 within the image scene as seaborne vessel(s). After detecting an object 102 as a seaborne vessel, the system 100 then determines whether that object 102 contains a shape of interest. A shape of interest can be a feature of a human (e.g., a head, an car, an arm, and so forth), a feature of a weapon (e.g., a barrel of a hand-held weapon, a targeting unit of a seaborne vessel's weapon system, and so forth), and so forth. The second processing module 114 can generate a data structure representative of the object(s) 102 with the shape(s) of interest and transmit the same to memory 106 for storage and later processing (e.g., processing by the third processing module 116). In the alternative, the data structure can be transmitted directly to the third processing module 116.

The processor 104 can include a third processing module 116 for comparing the shape of interest(s) to a reference shape(s). The memory 106 can include a data structure of labelled reference shapes, each reference shape being predetermined and labelled as a shape of interest. For instance, the reference shapes can be a data set of shapes of interest that had been previously identified and labeled from several different image files. The third processing module 116 can compare a shape of interest to one or more reference shapes, groups of shapes, and so forth. Statistical analyses can be used in this processing step to facilitate calculating and comparing, for the shapes of interest and/or the reference shapes: average shapes; averages for groups of shapes; covariance structures of shape variation; and so forth. The statistical analyses can also include clustering shapes based on similarity/difference. The third processing module 116 can generate a data structure representative of a result(s) of the comparison(s) and transmit the same to memory 106 for storage and later processing (e.g., processing by the fourth processing module 118). In the alternative, the data structure can be transmitted directly to the fourth processing module 118.

The processor 104 can include a fourth processing module 118 for classifying the object 102 as having a target characteristic when a shape of interest matches a reference shape. The target characteristic can be the object 102 including a human, a weapon, and so forth—e.g., the classifying the object 102 as having a target characteristic is determining that the object 102 includes a human, a weapon, and so forth. An exemplary matching analysis can involve representing shapes with mathematical descriptions of coordinate points, vectors connecting the coordinate points, features extracted representative of corners, edges, curvatures, and so forth. One or more algorithms can be used to identify similarities or differences in the represented shapes. Mathematical constructs such as distance metrics (e.g., Euclidean distance, Hausdorff distance, and so forth) can be used to quantify differences or similarities in two shapes being compared (e.g., the shape of interest and the reference shape). Other processing techniques can be used to account for transformations between the shape of interest and the reference shape, perform a transformation of the shapes or objects 102 before analyzing for similarities, and so forth. The fourth processing module 118 can generate a data structure representative of a classification(s) that the object(s) having a target characteristic(s) and transmit the same to memory 106 for storage and later processing (e.g., processing by the processor 104). In the alternative, the data structure can be transmitted directly to the processor 104.

The processor 104 can be configured to compare an interior area of an image curve of the classified object 102 to an interior area of an image curve of the reference shape to generate a scale factor. For instance, after the fourth processing module 118 has determined that an object 102 has a shape of interest that matches a reference shape, thereby classifying the object 102 as having a target characteristic, the processor 104 can compare an interior area of an image curve of that object to an interior area of an image curve of the reference shape used to classify the object as having a target characteristic. This comparison can be used to generate a scale factor. The scale factor can be a metric of the classified object 102 that is representative of the classified object's 102 size in relation to the image scene. In other words, the scale factor can be an assessment of scale for the object 102—e.g., it allows the system 100 to determine whether the object 102 in the image file(s) is of a scale that falls within interest. For instance, a seagoing vessel carrying personnel and a small toy-like vessel (e.g., a decoy, an unmanned vessel, and so forth) can both be deceptively classified by an object detection system as a seaborne object of interest without a distinction that one is a seagoing vessel of interest and the other is not. To obviate this, the processor 104 can be configured to designate the classified object 102 as an object-of-interest based on the scale factor.

The scale factor can be determined by measuring scale weight. This can be achieved, for example, by comparing a candidate curve's interior area to a reference curve's interior area—e.g., comparing an interior area of a curve of a shape of interest (or a candidate curve) to an interior area of a curve of a reference shape. Areas of curves or interior areas of curves can be calculated by multiplying all the pixels areas encompassed within the curve by a formula. The formula can be: Pixel-Scale=Range·IFOV where IFOV stands for instantaneous field of view. The curve area and reference area can be computed by summing all pixels contained within the respective contours' perimeters. A difference between areas of the candidate curve and the reference curve can be determined and compared to a threshold value. If the difference exceeds the threshold value, then the system 100 can determine that the object 102 associated with the shape of interest is not at the same or similar scale as that of the reference shape. If the difference equal to or less than the threshold value, the then the system 100 can determine that the object 102 associated with the shape of interest is at the same or similar scale as that of the reference shape. If it is determined that the object 102 is at the same or similar scale, then the processor 104 can continue to designate the classified object 102 as an object-of-interest based on the scale factor. If it is determined that the object 102 is not at the same or similar scale, then the processor 104 can designate the classified object 102 as not an object-of interest, or flag the object 102 for further processing, or designate the object 102 as a not-to-scale-object-of-interest, and so forth.

The system 100 can include a user interface configured to generate an output identifying the object 102 as an object-of-interest or as a non-object-of-interest. This can include a graphical user interface (GUI) configured to display the image scene and an overlay of that image scene with an indicator. The indicator can be a graphic, a text, and so forth. For instance, the processor 104 can generate a GUI for display by a computer device. The processor 104 can cause the GUI to generate the image file(s) that compose the image scene with a colored outline (e.g., a red outline) of the object(s) 102 that is/are object(s)-of-interest and no outline for non-object(s)-of interest.

As can be appreciated, the system 100 can be used in harsh environments. Therefore, the input image scene (the image file(s) received by the input module 110) can be of compromised resolution. The compromised resolution can be due to natural or artificial conditions. Yet, as demonstrated herein, the system 100 can still effectively and accurately distinguish and identify the object as an object-of-interest or as a non-object-of-interest.

As noted herein, the memory 106 can include a data structure of labelled reference shapes, each reference shape being predetermined and labelled as a shape of interest. The memory 106 can include one or more reference shapes created by a Karcher mean, a human-drawn shape, and so forth. The reference shapes can conform (e.g., imitate, be representative of, and so forth) to an expected object 102 or an expected shape of interest of the object 102 to be identified. Which environment (e.g., at sea, on land, in space, and so forth) and under which situations (e.g., warfare operations, policing operations, patrolling operations, rescue operations, and so forth) the system 100 will be used can be predetermined. In this regard, the classification techniques used to classify objects 102 and shapes of interest can be limited to, directed to, or tailored for expected objects and expected shapes of interest—e.g., the classification models, data tables, data structures, and so forth can be tailored to the environment and situation.

In some embodiments, the processor 104 can be configured to perform the shape analysis technique via an elastic shape analysis technique. As noted herein, the processor 104 can include processing modules for identifying one or more shapes of interest of one or more objects 102, comparing the shape of interest(s) to a reference shape(s), and classifying the object 102 as having a target characteristic when a shape of interest matches a reference shape. One or more of these processing steps can be performed via elastic shape analysis. Elastic shape analysis can involve comparing curves and surfaces of objects using algorithms that can account for variations (e.g., changes in size, rotation, re-parameterization, and so forth) in the curves and surfaces. The algorithm can account for variations by representing shapes as mathematical functions (e.g., functional representations of points on a shape or a curve) which facilitates application of statistical methods (e.g., square-root velocity function (SRVF), spherical harmonic function, and so forth) to analyze shape variations, identify patterns, perform comparisons and so forth. Use of functional representations allows for shape comparisons to be performed regardless of transformations (e.g., translations, rotations, scale, and so forth)—e.g., shape comparisons can be invariant to a transformation. The processor 104 can be configured to perform the shape analysis technique by quantifying a distance between a curve of a perimeter of the shape of interest of the object 102 and a curve of a perimeter of the reference shape. The processor can then measure a distance between the curve of the perimeter of the shape of interest of the object 102 and the curve of the perimeter of the reference shape. With elastic shape analysis, the processor 104 can use a Riemannian metric(s) defined on the space(s) of the functional representations to determine distance(s) between two shapes (e.g., the shape of interest and the reference shape). Thus, the Riemannian metric(s) can be used to quantify difference(s) or similarity(ies) between the shape of interest and the reference shape even when the two are transformed. As can be appreciated, processor 104 can be configured to quantify the distance using SRVF, and then measure the distance include using a Riemannian metric.

In some embodiments, the processor 104 can be configured to perform the shape analysis technique via a path straightening technique. For instance, the processor 104 can be configured to determine that the shape of interest matches the reference shape based on a path straightening technique. An exemplary path straightening technique can be the one discussed later related to the “Path-Straightening Algorithm” or PSA.

An exemplary embodiment can relate to a method for identifying when a target characteristic of an object 102 in an input image scene is deemed to render the object 102 to be an object-of-interest. The method can include receiving in real time an image scene captured by an image capture device. The method can include performing a shape analysis technique by scanning the image scene to identify an object, identifying a shape of interest of the object 102, comparing the shape of interest to a reference shape, classifying the object as having a target characteristic when the shape of interest matches the reference shape. The method can include comparing an interior area of an image curve of the classified object to an interior area of an image curve of the reference shape to generate a scale factor. The method can include designating the classified object as an object-of-interest based on the scale factor.

The method can include generating an output identifying the object 102 as an object-of-interest or as a non-object-of-interest.

The input image scene can be of compromised resolution due to natural or artificial conditions.

The method can include creating one or more reference shapes using a Karcher mean or a human-drawn shape which conforms to an expected object 102 or an expected shape of interest of the object to be identified.

The shape analysis technique can include an elastic shape analysis technique.

The shape analysis technique can include quantifying a distance between a curve of a perimeter of the shape of interest of the object 102 and a curve of a perimeter of the reference shape. The method can include measuring a distance between the curve of the perimeter of the shape of interest of the object and the curve of the perimeter of the reference shape.

The method can include quantifying the distance includes using a Square Root Velocity function. The method can include measuring the distance include using a Riemannian metric. The shape analysis technique can include a path straightening technique.

The method can include determining that the shape of interest matches the reference shape based on the path straightening technique.

The scale factor can be a metric of the classified object that is representative of the classified object's 102 size in relation to the image scene.

### EXAMPLES

The following are exemplary systems, methods, and implementations of the embodiments disclosed herein. While the examples may focus on one implementation, it is understood that this is exemplary and the embodiments disclosed herein are not limited thereto.

An exemplary solution can employ elastic shape analysis techniques through manifold learning to detect partially concealed humans and other distinctive features that mark a vessel as a crewed threat. This approach has the advantage of requiring minimal computational resources while being robust to configuration changes in the crew. The following examples provide a demonstration of our algorithm's effectiveness in performing detections and distinguishing between (un)manned vessels in multiple scenarios.

Within the first few weeks of the war between Russia and Ukraine, the Ukrainian Navy ships were either captured, destroyed, or scuttled. Furthermore, the Russians imposed a blockade that ruined the Ukrainian's ability to sell their grain. Nevertheless, the Ukrainians have prevailed against the Russian Navy by engaging in asymmetric warfare. Inclusive in this strategy is the use of a kamikaze drone vessel (KDV) known as the Maritime Autonomous Guard Unmanned Robotic Apparatus V5 (MAGURA V5). With a range of 800 km and a 200 kg explosive payload the MAGURA V5 can deliver more explosives at a longer range than an anti-ship missile. As of this writing, the use of the MAGURA V5 KDV has resulted in the sinking of two Russian tank-carrying landing vessels the Olenegorsky Gornyak (August 2023) and the Caesar Kunikov (February 2024), the guided missile corvette Ivanovets (February 2024), and the patrol corvette Sergei Kotov (March 2024).

To recognize, engage, and destroy attacking KDVs, we must be cognizant of the fact that recognition of a genuine KDV may occur in adverse sea, weather, and lighting conditions or in an outright naval battle. Such adverse conditions necessitate the ability to reason under uncertainty. For example, there may be only one image captured of the item of interest while obtaining it in choppy, rainy seas. Furthermore, determination of whether an attacking vessel is manned can only be accomplished by recognizing only a partial exposure of the human pilot or certain features common to manned attack vessels-such as flags and/or machine guns. The exemplary approach to addressing the challenges imposed by distinguishing between KDV's and manned vessels creates a low size weight and power (low-SWaP) perception platform which operates on the assumption that training data is minimal to non-existent and/or may operate in adverse lighting, sea, and weather conditions. It is well-known that many prevailing deep-learning pattern classification paradigms are quite capable of meeting an accurate classification performance metric; however, their hardware-usage costs as measured by memory and processor consumption do not lend themselves immediately to a relatively lightweight, low-SWaP application. Furthermore, these prevailing deep-learning-based algorithms require an enormous amount of training data in multiple environmental conditions in order to provide a credible detection and classification prediction. Therefore, the exemplary implementation disclosed herein provides a means of safely providing an understanding and classification of manned/unmanned vessels when there are adverse circumstances under which the item-of-interest imagery is obtained, training data is lacking and/or hardware resources are costly. The exemplary manned/unmanned detection and classification solution is based on the concepts of elastic shape analysis developed by Anuj Srivastava et al; specifically, we explore the path straightening algorithm (PSA). Furthermore, we have added a modifications to their original algorithm such that it obtains a greater degree of applicability to our particular problem of distinguishing between (un)manned vessels in adverse lighting/weather circumstances.

### Shape Analysis Overview

### Practical Applications of Manifolds Towards Shape Analysis

The practical application of manifolds for the engineering problems associated with pattern recognition and object classification is a topic of much research. The utilization of manifolds—in images specifically—is motivated by the idea of optimizing an objective function over a Euclidean space with the optimization solution being generated over a constrained set. In our case, this constrained set is defined as a family of closed contours representing test and reference contours.

In practical terms, what this leads to is the development of a means of projecting high-dimensional data onto a much simpler structure and then being able to make predictions about this data's consistency with similarly projected reference data. For our set of problems, this manifold-projection comparison methodology has the advantage of being lightweight in terms of training since only the reference data to be compared against need be stored. Furthermore, it has the advantage of being lightweight in terms of processor usage since it requires only the storage of a manifold projection and comparison algorithm rather than a large multi-layered network occupying multiple GPUs.

In our case, we are concerned with shape analysis as it applies to a human crew members' pose and their activity recognition. To achieve this goal, we establish the following prerequisites:
1) Utilization of a suitable reference silhouette.
2) The ability to model variations among detected shapes.
3) Quantification of differences amongst shapes.
4) Performance of classification using shapes projected onto their respective manifolds.

The first requirement may be obtained via the construction of a shape prior through a statistical mean (known as the Karcher mean of shapes) which conform to a notion of what constitutes an item of interest within the observed region of interest. The first requirement may also be met by simply constructing a target-like silhouette representing the anticipated item of interest. In our case, we chose the latter option and, as we will see, even an abstract notion of what constitutes a human form or weapon is sufficient for our pattern-classification/detection needs.

Broadly speaking, the remaining requirements can be achieved within a Riemannian-manifold framework as it is applied to a set of geodesics. Modeling the variations among shapes, quantifying their differences, and ultimately performing shape-based classifications starts first by preserving the intrinsic properties that define shape after it has been altered in size, rotated and/or translated. We will show in the next sections how the square root velocity function, the PSA, and our APSA algorithm allow us to achieve these ends.

### The Square Root Velocity Function and Riemannian Manifolds for Shape Analysis

The Square Root Velocity Function (SRVF) was first introduced by Srivastava et al. The motivation behind this function is that it allows for the construction of an L² norm for the purpose of performing a quantification of distances between two curves which represent the perimeter of a given shape. What follows is a more formal definition of the nature of the SRVF.
Let β be a parameterized curve (β: D→ [symbol] ) where D is the domain of parameterization. In our case, we are concerned with closed curves which simply means that the first element of β is equal to the last element in β. In our case, we assume that all members of D are strictly continuous, closed, and whose elements are within the set [0, 1]. We define a mapping F: [symbol] → [symbol] according to

$$F ( v ) = \frac{v}{\sqrt{‖ v ‖}}$$

if ∥v∥≠0 and 0 otherwise. Where ∥v∥ is the Euclidean 2-norm in [symbol] and F is a continuous (closed) mapping. For our purposes of analyzing the shape of β, we will represent it using the SRVF defined as q: D→ [symbol] , where:

$$q ( t ) = F ( β ( t ) ) = \frac{β ( t )}{\sqrt{( ‖ β ( t ) ‖ )}} \qquad ( 1 )$$

Practically speaking, our first use of this function centers on the shape β—being defined as a sequence of tuples which constitute the x and y elements of an item-of-interest's perimeter within the area-of-interest examined—being converted into the SRVF representation q. This is the first step that enables the ability to compute a distance between the test curve βt and the reference curve βr. By using the SRVF, we can now ignore scale since every shape represented by the SRVF is placed within the set [0, 1]. Furthermore, by placing the curves in the SRVF framework, we can perform calculations of the distances between candidate curve βt and reference curve βr by means of the L2 norm.

The next ingredient needed is the elastic Riemannian metric—a metric that measures a combination of stretching and bending to optimally deform one curve into another. This metric is equal to the standard L2 metric under the change of variable from β to q. Thus, it has been shown that the use of this metric constitutes the creation of a set of similarity-invariant metrics which can measure the differences (or distance) between similarly transformed curves.
Consider the set of all closed-shape spaces defined below as [19]:

$${S}_{c}^{∞} = \{ q ∈ {𝕃}^{2} ( [ 0 , 1 ] , {ℝ}^{2} ) \vert ‖ q ‖ = 1 , {\int }_{0}^{1} q ( t ) \vert q ( t ) \vert dt = 0 \} \qquad ( 2 )$$

The imposition of our Riemannian metric on this shape space thus completes that manifold's construction.

The following definition serves as a good understanding of a geodesic and its significance: “A geodesic on a Riemannian manifold is defined as a shortest length path with respect to the chosen Riemannian metric between one point and another. Geodesic distance is defined as the length of such a path, and henceforth when we speak of a distance between shapes, we are referring to a geodesic on a manifold”. We are concerned with the measurement of distances among closed curves βₜ and βᵣ, where βₜ may have undergone diffeomorphic operations such as rotations, transpositions, or similarity-preserving elastic deformations. We are in fact concerned with performing an optimization over all such diffeomorphic operations such that we can calculate an approximate solution to the following optimization problem:

$${d}_{{S}_{c}^{∞}} = {lim}_{O ∈ SO , γ ∈ Γ} {d}_{{S}_{c}^{∞}} ( {q}_{r} , O ( {q}_{t} , γ ) ) \qquad ( 3 )$$

where qₜ and qᵣ serve as the SRVF representations of βₜ and βᵣ respectively, O∈SO describe the operations on shapes such as rotations and translations and γ∈Γ serve as the elastic deformations performed on a shape. This calculation of the optimal transformations necessary to perform a comparison between two similar curves contained within the Riemannian manifolds such that we construct a minimizing geodesic and thus forms the basis of the path straightening algorithm.

### The Path-Straightening Algorithm

The PSA was first introduced by Srivastava et al. In summary, the path-straightening algorithm is an iterative optimization algorithm which operates by means of gradient descent on the space of all continuous paths that begin at the SRVF representation of qₜ and qᵣ. It is meant to find a minimizing geodesic path between qₜ and qᵣ. The summation of the path length serves as a PSA score and thus determines how “close” qₜ and qᵣ are from one another. The smaller the score, the more similar qₜ and qᵣ happen to be and thus a detection and classification can be performed.

We present the algorithmic steps that constitute the PSA. To streamline exposition, we do not explain the steps to a great level of detail but do provide references that an interested reader can pursue if necessary.
1) Given test and reference curves βₜ and βᵣ, compute their representations qₜ and qᵣ in

$${S}_{c}^{∞} .$$

2) Initialize a geodesic path α between qₜ and qᵣ in

$${S}_{c}^{∞}$$

and project each point along it in

$${S}_{c}^{∞}$$

using step 1.
3) Compute the velocity vector field dα/dτ along the path α using the algorithm defined in
4) Compute the covariant integral of dα/dτ, denoted by u, using the algorithm defined in [12]
5) Compute the backward parallel transport of the vector along u(1) using the algorithm defined in [12] denote it by ũ.
6) Compute the full gradient vector field of the energy E along the path α, denoted by w, using w(τ)=u(τ)−τũ(τ) by means of the algorithm defined in [12].
7) Update α along the vector field w using the algorithm defined in [12]. If

$${\sum }_{τ = 1}^{w} 〈 w ( τ ) , w ( τ ) 〉$$

w(τ)) is small, then stop. Else, return to step 3.
8) Compute the path length along α and report this as the scoring distance between qₜ and qᵣ.

### The Augmented Path-Straightening Algorithm

Note that the SRVF and thus the PSA have been explicit about maintaining agnosticism about the size of the objects in question. All contours are scale invariant since they are meant to be compressed to a unit length prior to application of the PSA. However, this agnostic approach—while useful for calculating a score that indicates how (dis)similar two contours happen to be—can indicate, for example, a toy boat is the same as an actual boat when in fact they are not. When performing a scene analysis such that items of interest are detected and classified, knowledge of scale becomes vitally important since certain candidate shapes will then and therefore be dismissed from consideration because they are not the right size.

Thus, the APSA algorithm is meant to inject knowledge of what we will call scale weight so that, for example, a smaller drone vessel will be distinguished from a larger manned vessel. Furthermore, it can eliminate shapes who may be too small or too large for consideration. The following formula is used as a means of altering the final PSA score so that similar, but obviously too large or too small objects are rejected, and a better detection and classification can be performed.

Scale weight is measured by comparing a candidate curve's interior area (in square meters) to a reference curve's area. Note that the area of a curve is calculated by multiplying all the pixels encompassed within the curve by the formula: Pixel-Scale=Range·IFOV where IFOV stands for instantaneous field of view. The curve area and reference area are computed by simply performing a sum of all pixels contained with the respective contours' perimeters.

$$scale weight = 1 + \frac{\vert curve area - reference area \vert}{reference area} \qquad ( 4 )$$

The larger the difference between the curve area and the reference area, the greater the modification cost and thus elements which are not the same scale are thus separated from each other. As we will see, the application of the APSA algorithm leads to a means of quickly assessing the presence/absence of a KDV.

### Experimental Setup and Classification Methodology

Our particular set of experimental circumstances are meant to perform human detections and classifications on images of small vessels in various poses and configurations. Additionally, we are considering certain “tells” that mark a small vessel as being manned (and potentially hostile), namely the presence of heavy machine guns. This choice matches multiple scenarios that conform to scenes wherein a potential attacker is attempting to harass or engage another vessel. Identifying the humans present in these scenes quickly in a low-SWaP platform allows for greater domain security. Note that we are not considering vessels of a corvette's size or larger since it is assumed that these vessels are crewed.

As we alluded to earlier, we only need consider an extraordinarily small number of reference candidates as our “training set”. Furthermore, we need only consider a single image representing our scene. The training set in our case needs only be an abstract representation of what a human or relevant feature on a vessel happens to be.

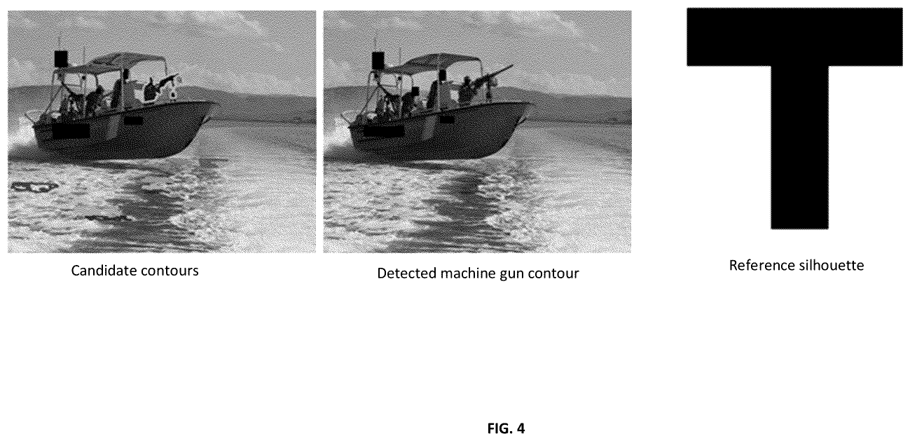

The images in FIG. 4 represent a scene containing a manned and armed patrol vessel. The candidate contours outlined in the image are generated by means of the marching squares algorithm. The contours represented are a subset of all contours possible. After removing contours that are either not closed, too long, or too short, fourteen candidates remain. In this image, the true range and IFOV were not available, so maximum and minimum curve lengths were estimated based on comparisons to references within the image. The detected machine gun is outlined in the image. FIG. 4 also shows our reference silhouette used to detect the machine gun present in the patrol boat. Note that we do not require an understanding of a specific type of machine gun. All we need is a generalized or abstract notion of what constitutes a machine gun.

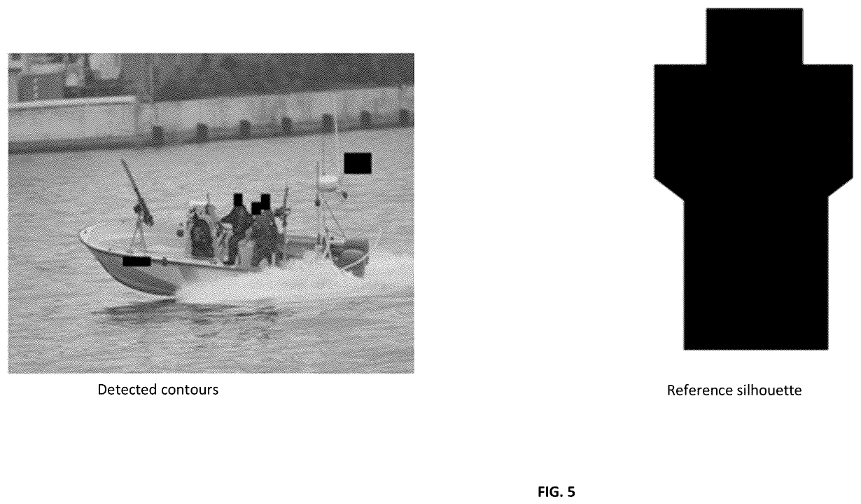

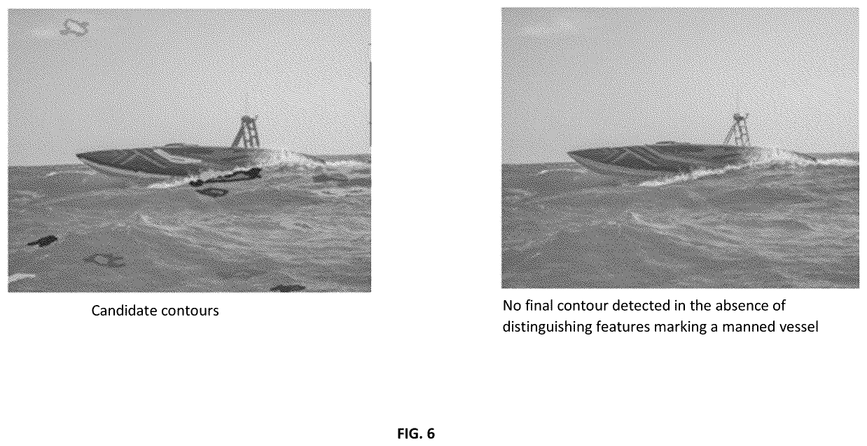

When considering humans, FIG. 5 has an image of a manned patrol vessel with humans in various poses. The detected and classified humans are outlined in red. This image is paired with its human reference silhouette. Again, we only need consider an abstract notion of what constitutes a human. When humans, machine guns, flags or any other distinguishing features marking a manned vessel are absent in FIG. 6, we can designate the vessel being considered a drone. The figure of a drone boat lacks the features in its candidate contours that allow us to designate it as manned and thus has no red contours indicating their presence.

This abstraction in our reference contours is done to prevent “overshooting” the classification of the shapes extracted since the shapes extracted are not necessarily detailed themselves. The important thing to consider is the geometric relationships maintained amongst the reference and candidate contours. In the case of detecting/classifying humans, we are only concerned with the relationship of the head to the shoulder. In the case of machine gun detection/classification, we need only concern ourselves with the geometric relationship between the gun sitting atop a mount.

We now consider the steps taken to perform detections and classifications.
Optionally perform image enhancement techniques on the input image.
Perform the marching squares segmentation algorithm to extract a set of candidate contours.
Remove from consideration candidate contours which are too large or too small—these metrics are chosen by ensuring that the surface area represented by the extracted contours conform to the expected surface area represented by the references.
Perform the APSA algorithm on the respective reference and remaining candidate contours available.
Optionally utilize a set of progressive APSA-generated score thresholds to determine what candidate contours remain.
Select the elements within the scene with the minimum reference-matching scores.

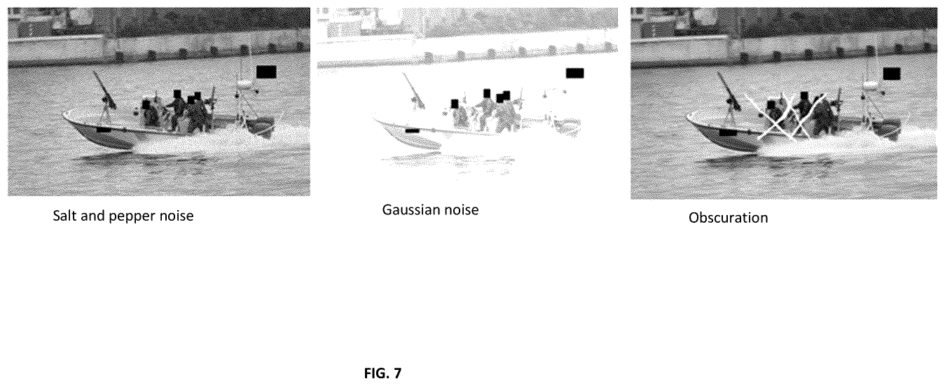

To capture the possible operations that our proposed solution will encounter, we consider a variety of vessels, both manned and unmanned. Furthermore, we add “noise” to the images in the form of MATLAB's salt and pepper noise and gaussian noise generators, and obscuration. The point of these image modifications is to ensure that we can maintain robustness in the distinction between manned/unmanned vessels. Examples of the types of noise/obscuration we are considering are given in FIG. 7.

The amount and type of obscuration that we could introduce into our sample imagery is unbounded. Therefore, to keep the case for our algorithm's efficacy intact, we are introducing non-degenerate obscuration that masks a portion of the features present in the image while preserving the presence of at least some portion of the object we seek to detect. Note that there is no well-defined and curated dataset comprised of (un)manned vessels available. Hence, in the absence of an “ImageNet of (un)manned vessels” we choose a random sample of images to demonstrate APSA's effectiveness in this classification realm.

### Results

### Results of Applying APSA to Multiple (Un)Manned Scenes

The following set of images and the accompanying noise patterns are the result of applying our APSA algorithm mentioned above.

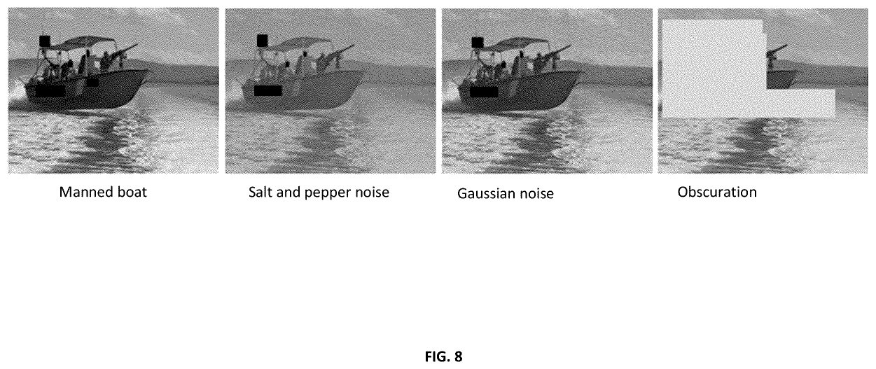

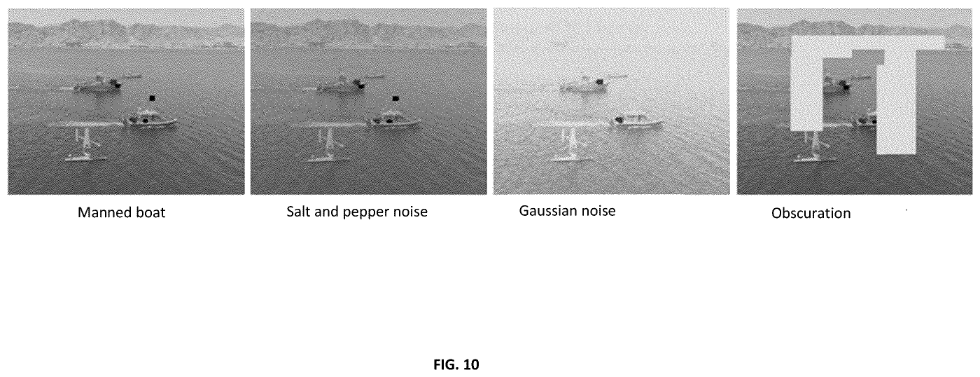

The algorithm is able to detect weapon shapes in the images containing the manned water vessels, as evidenced by FIG. 8. When the images are subjected to noise or obscurations, the model is still able to detect the machine gun on the vessel. The algorithm is also able to detect humans in various configurations as is demonstrated. FIG. 10 demonstrates an example where no human or a machine gun were detected in the instance of an unmanned vessel; however, humans are detected in the instance of manned vessels. It should be mentioned that the parameters were kept at wide enough range to make sure the model maintains robustness and is not overfitting.

The effect of applying APSA on individual shapes illustrates the cost associated with the deforming the reference silhouette such that it conforms to the candidate contour extracted from the scene. The non-human “clutter contours” have a score which is greater than 0.6 whereas the human-like contours have a contour score that is less than 0.6.

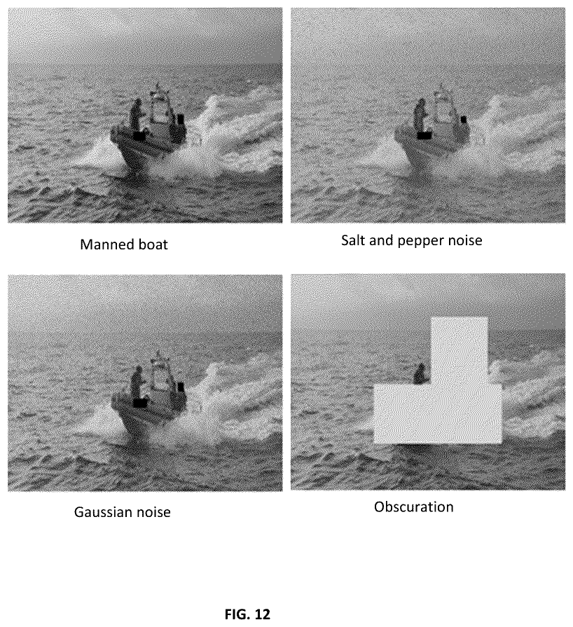

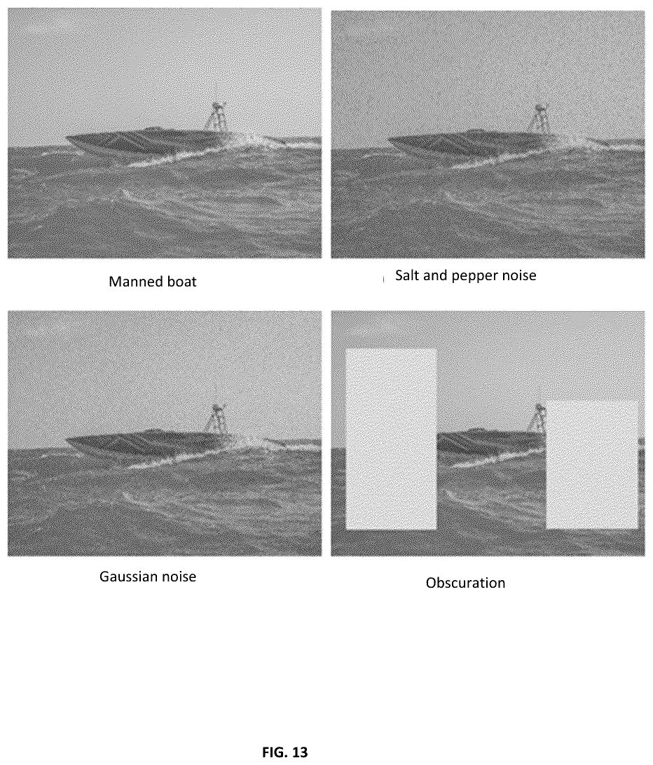

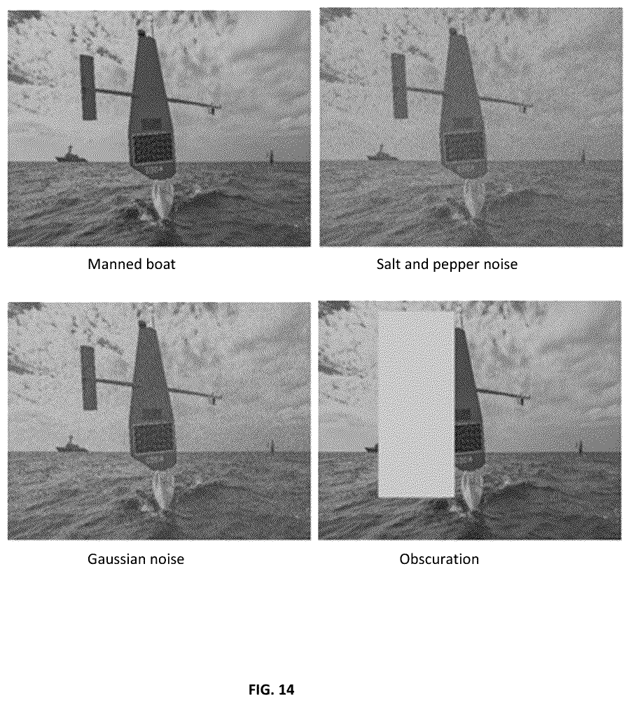

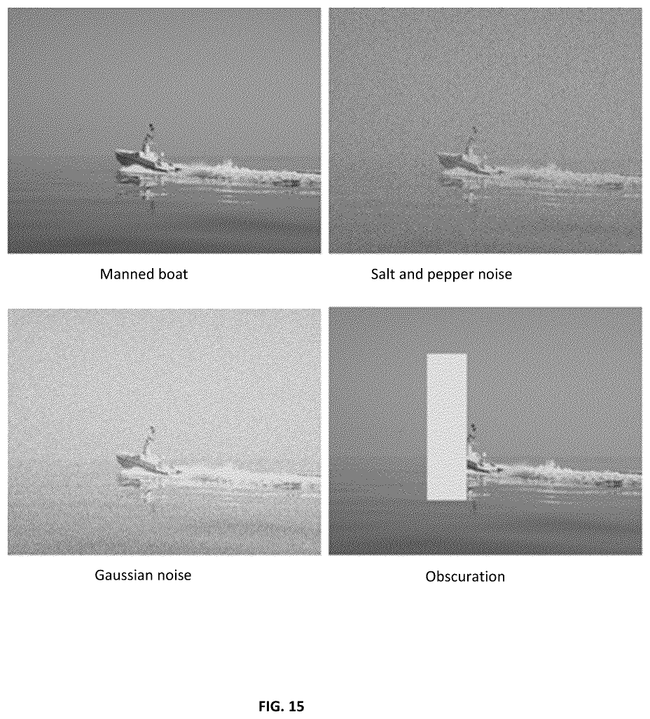

Additional examples of detecting humans and weapons in (un)manned vessels can be found in FIGS. 12, 13, 14, and 15 which represent additional results of applying our APSA algorithm to images containing manned and unmanned vessels in the presence of noise and obscurations.

Points at which the APSA Fails

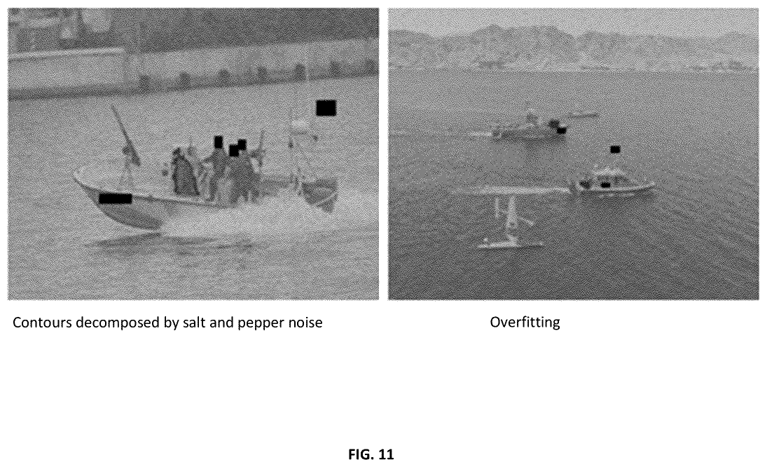

After performing curve extraction on the scene using the marching squares algorithm, there are instances (see FIG. 11) in which human contour is not captured due to being decomposed by noise, or the feature to be captured can only be obtained by extreme specificity (e.g., overfitting).

### DISCUSSION

The APSA operates on a single-look basis and the only “training” it requires is the use of a set of reference contours. This makes it rather lightweight in terms of memory consumption; our 2-element reference contours only required 100 double-precision numbers per reference or 1.6 kilobytes. Furthermore, using a (non-parallelized) MATLAB instantiation of APSA, it performed a classification on a reference vs. a set of candidates in 60 milliseconds. It is expected that with optimizations and porting to specialized hardware this time would be reduced. It is important to note that classification performance relies upon trust in the contour extractor to provide contours which may be compared against the reference using the APSA. The contours being matched provide a significant piece of information, but the inclusion of metadata elements (such as pixel scale) makes a huge difference in classification accuracy. Highly cluttered/obscured scenes are far more challenging, but the scale metadata element can make correct classification easier. This component of our classification effort is evidenced by the expected size of the objects to be classified in our imagery since human beings occupy a well-defined scale within the images to be evaluated.

Misclassification could occur with objects whose contours are decomposed. This deficiency can be overcome by providing a Bayesian classifier to understand the probability that an object detected is a human or a particular feature associated with human-piloted boats. The use of scale-weighting has been demonstrated with the ability to overcome an incomplete contour since the contour elements that do remain are more “human-like” than competing contours available. It should be noted that APSA can serve as a “drop in” for any prevailing object detection and classification algorithm. In other words, it can serve as a member of an ensemble of object recognizers offering a further insight into an object's class by minimizing the loss incurred in the object classification's inference step.

### REFERENCES

The following references are incorporated herein by reference in their entireties.
[1] L. James, “Ukrainian Navy scuttles flagship as Russia advances on Mykolaiv.” independent.com.uk, http://www.independent.co.uk/news/world/europe/ukrainenavy-frigate-sunk-mykolaiv-b2029108.html (accessed Apr. 30, 2024).
[2] “Analysis: Russian Armed Forces capture dozen Ukrainian ships in Berdyansk.” navyrecognition.com. http://www.navyrecognition.com/index.php/focus-analysis/11502-analysis-russian-armed-forces-capture-dozen-ukrainian-ships-in-berdyansk.html (accessed Apr. 30, 2024).
[3] S. Harris, “U.S. intelligence document shows Russian naval blockade of Ukraine.” washingtonpost.com. http://www.washingtonpost.com/national-security/2022/05/24/naval-blockade-food-supply-ukraine-russia/(accessed Apr. 30, 2024).
[4] S. Brown, “ANALYSIS: The Magura-V5 Sea Drone—Scourge of Russia's Black Sea Operations.” kyivpost.com. http://www.kyivpost.com/analysis/29068 (accessed Apr. 30, 2024).
[5] “MAGURA V5.” en.wikipedia.org. http://en.wikipedia.org/wiki/MAGURA V5 (accessed Apr. 30, 2024).
[6] B. Cole, “What Is the Olenegorsky Gornyak? Russian Warship Towed After Drone Strike.” newsweek.com. http://www.newsweek.com/olenegorsky-gornyak-ship-black-sea-drone-strike-1817704 (accessed Apr. 30, 2024).
[7] P. Kirby, “Russian landing ship Caesar Kunikov sunk off Crimea, says Ukraine.” BBC.com. http://www.bbc.com/news/world-europe-68292602 (accessed Apr. 30, 2024).
[8] V. Cotovio, Y. Kesaieva, R. Gigova, and C. Edwards, “Ukraine says it sank Russian warship off coast of Crimea and unleashed ‘massive’ missile barrage on peninsula.” CNN.com. http://www.cnn.com/2024/02/01/europe/ukraine-russian-warship-crimea-ivanovets-intl/index.html (accessed Apr. 30, 2024).
[9] S. Vlasova, and B. Lendon, “Ukraine's drones sink another Russian warship, Kyiv says.” CNN.com. http://www.cnn.com/2024/03/05/europe/russian-warship-destroyed-ukraine-intl-hnk-ml/index.html (accessed Apr. 30, 2024).
[10] Y. Zoria, “Magura V5 naval drones to get anti-air and dive capabilities.” euromaidanpress.com. http://euromaidanpress.com/2024/03/14/magura-v5-naval-drones-to-get-anti-air-and-dive-capabilities/ (accessed Apr. 30, 2024).
[11] A. Krizhevsky, I. sutskever, G. E. Hinton, Imagenet Classification with deep convolutional networks, in Advances in Neural Information Processing Systems, 2012, pp. 1097-1105.
[12] A Srivastava, E. Klassen, S. Joshi, and I Jermym, “Shape analysis of elastic curves in Euclidean spaces”, IEEE Transactions on Pattern Analysis and Machine Intelligence, vol. 33(7), pp. 1415-1428 July 2011.
[13] A. Srivastava, X. Guo, H. Laga, “Advances in geometrical analysis of topologically-varying shapes”, Proc of the 2020 IEEE 17th International Symposion on Biomedical Imaging Workshops, Iowa City, IA, April 2020.
[14] S. Lohit and P. Turaga, “Learning invariant Riemannian geometric representations using deep nets,” in Proc. Of International Conference on Computer Vision Workshop (ICCVW), Venice, October 2017.
[15] M. Ali, “Statistical learning over manifolds and its applications in computer vision”, PhD dissertation, College of Computing and Mathematics, Charles Sturt University, Bathurst, 2018.
[16] A. Srivastava, P. Turaga, and S. Kurtek. On Advances in Geometric Approaches for 2D and 3D Shape Analysis and Activity Recognition, Journal of Image and Vision Computing 30 (6), June 2012.
[17] W. Huang, Y. You, K. Gallivan, P.-A. Absil, Karcher Mean in Elastic Shape Analysis, Proc of the 1st Int'l Workshop on DIFFerential Geome-try in Computer Vision for Analysis of Shapes, Images, and Trajectories (DIFF-CV 2015), pp 2.1-2.11, 2015.
[18] D. T. Robinson, “Functional data analysis and partial shape matching in the square root velocity framework”, Ph.D dissertation, Dept. of Statistics, Florida State University, Tallahassee, 2012.
[19] D. W. Bryner, “2D affine and projective shape analysis, and Bayesian elastic active contours”, Ph. D dissertation, Dept. of Statistics, Florida State University, Tallahassee, 2013.
[20] C. Maple, Geometric Design and Space Planning Using the Marching Squares and Marching Cubes Algorithms. Proc. of Int'l Conf. on Geometric Modeling and Graphics, pp. 90-95, 2003.
[21] MATLAB. (R2024a), The MathWorks, Inc. [Online]. Available: https://www.mathworks.com/help/images/ref/imnoise.html#d126e175201.
[22] “US Coast Guard (USCG) Personnel assigned to Port Security Unit De-tachment Delta (PSUDD) conduct a high-speed patrol aboard A 25-foot Transportable Port Security Boat (TPSB), as a part of a routine force pro-tection procedure. PSUDD is supporting Joint Task Force-Guantanamo Bay (JTF-GTMO) and Operation ENDURING FREEDOM.” cata-log.archives.gov, https://catalog.archives.gov/id/6640750 (accessed Jul. 15, 2024).
[23] “US Coast Guard Port Security Unit 313, Tacoma, Washington, team members power a 25-foot Boston Whaler, Transportable Port Security Boat, during a bay and dock security drill during Exercise FOAL EAGLE 2000 in Pusan, Korea. The boats are used to protect high-value assets from small boat and swimmer attacks. Foal Eagle is held annually in South Korea to demonstrate US and South Korean military cooperation and is the US Militarys largest Joint-Service, Multi-National field training drill. This years drill involves about 25,000 active duty, Reserve, and National Guard troops from the the United States and bases throughout the Pacific Command.” archives.gov, https://catalog.archives.gov/id/6514547 (accessed Jul. 15, 2024).
[24] Resnick, David, “Unmanned Operation.” defense.gov, https://www.defense.gov/Multimedia/Photos/igphoto/2002904552/ (accessed Jul. 15, 2024).
[25] “Digital Shield” defense.gov, https://www.defense.gov/Multimedia/Photos/igphoto/2003086140/(accessed Jul. 15, 2024).
[26] “Boat Acquisition.” dcms.uscg.mil, https://www.dcms.uscg.mil/Our-Organization/Assistant-Commandant-for-Acquisitions-CG-9/Programs/Surface-Programs/Boat-Acquisition-Program/ (accessed Jul. 15, 2024).
[27] Vergun, David, “DOD Modernization Relieson Rapidly Leveraging Commercial Technology.” defense.gov. https://www.defense.gov/News/News-Stories/Article/Article/3277453/dod-modernization-relies-on-rapidly-leveraging-commercial-technology/ (accessed Jul. 15, 2024).
[28] Chebahtah, Anita, “Unmanned Defender.” defense.gov, https://www.defense.gov/Multimedia/Photos/igphoto/2003148894/ (accessed Jul. 15, 2024).

It will be understood that modifications to the embodiments disclosed herein can be made to meet a particular set of design criteria. For instance, any of the components, features, or steps of the system, apparatus, or method can be any suitable number or type of each to meet a particular objective. Therefore, while certain exemplary embodiments of the systems and methods disclosed herein have been discussed and illustrated, it is to be distinctly understood that the invention is not limited thereto but can be otherwise variously embodied and practiced within the scope of the following claims.

It will be appreciated that some components, features, and/or configurations can be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiments. Thus, the components, features, and/or configurations of the various embodiments can be combined in any manner and such combinations are expressly contemplated and disclosed by this statement.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning, range, and equivalence thereof are intended to be embraced therein. Additionally, the disclosure of a range of values is a disclosure of every numerical value within that range, including the end points.

What is claimed is:

1. A system for identifying when one or more target characteristics of an object in an input image scene are deemed to render the object to be an object-of-interest, the system comprising:
an input module for receiving in real time the image scene captured by an image capture device;
a processor comprising plural processing modules for performing a shape analysis technique, wherein:
a first processing module for scanning the image scene to identify the object;
a second processing module for identifying one or more shapes of interest of the object;
a third processing module comparing the one or more shapes of interest to one or more reference shapes; and
a fourth processing module for classifying the object as having one or more target characteristics when one or more shapes of interest match the one or more reference shapes;
wherein the processor is configured to:
compare an interior area of an image curve of the classified object to an interior area of an image curve of the reference shape to generate a scale factor; and
designate the classified object as an object-of-interest based on the scale factor; and
a user interface configured to generate an output identifying the object as an object-of-interest or as a non-object-of-interest.

2. The system of claim 1, wherein:
the input image scene is of compromised resolution due to natural or artificial conditions.

3. The system of claim 1, comprising:
a memory including the one or more reference shapes created by a Karcher mean or a human-drawn shape which conforms to an expected object or an expected shape of interest of the object to be identified.

4. The system of claim 1, wherein:
the processor is configured to perform the shape analysis technique via an elastic shape analysis technique.

5. The system of claim 4, wherein the processor is configured to perform the shape analysis technique by:
quantifying a distance between a curve of a perimeter of the one or more shapes of interest of the object and a curve of a perimeter of the one or more reference shapes; and
measuring a distance between the curve of the perimeter of the one or more shapes of interest of the object and the curve of the perimeter of the one or more reference shapes.

6. The system of claim 5, wherein:
quantifying the distance includes using a Square Root Velocity function; and
measuring the distance includes using a Riemannian metric.

7. The system of claim 1, wherein:
the processor is configured to perform the shape analysis technique via a path straightening technique.

8. The system of claim 1, wherein:
the scale factor is a metric of the classified object that is representative of the classified object's size in relation to the image scene.

9. A method for identifying when one or more target characteristics of an object in an input image scene are deemed to render the object to be an object-of-interest, the method comprising:
receiving in real time the image scene captured by an image capture device;
performing a shape analysis technique by:
scanning the image scene to identify the object;
identifying one or more shapes of interest of the object;
comparing the one or more shapes of interest to one or more reference shapes; and
classifying the object as having one or more target characteristics when the one or more shapes of interest matches the one or more reference shapes;
comparing an interior area of an image curve of the classified object to an interior area of an image curve of the one or more reference shapes to generate a scale factor; and
designating the classified object as an object-of-interest based on the scale factor.

10. The method of claim 9, comprising:
generating an output identifying the object as an object-of-interest or as a non-object-of-interest.

11. The method of claim 9, wherein:
the input image scene is of compromised resolution due to natural or artificial conditions.

12. The method of claim 9, comprising:
creating the one or more reference shapes using a Karcher mean or a human-drawn shape which conforms to an expected object or an expected shape of interest of the object to be identified.

13. The method of claim 9, wherein:
the shape analysis technique includes an elastic shape analysis technique.

14. The method of claim 13, wherein the shape analysis technique includes:
quantifying a distance between a curve of a perimeter of the one or more shapes of interest of the object and a curve of a perimeter of the one or more reference shapes; and
measuring a distance between the curve of the perimeter of the one or more shapes of interest of the object and the curve of the perimeter of the one or more reference shapes.

15. The method of claim 14, wherein:
quantifying the distance includes using a Square Root Velocity function; and
measuring the distance includes using a Riemannian metric.

16. The method of claim 9, wherein:
the shape analysis technique includes a path straightening technique.

17. The method of claim 9, wherein:
the scale factor is a metric of the classified object that is representative of the classified object's size in relation to the image scene.
